(19) United States
(12) Patent Application Publication
(10) Pub. No.: US 2012/0119664 A1
(43) Pub. Date: May 17, 2012

(54) POWER-SAVING LIGHT STRING

(76) Inventor: FU-HSIEN HSU, Hsinchu City (TW)

(21) Appl. No.: 12/944,678

(22) Filed: Nov. 11, 2010

(51) Int. Cl. H05B 37/02

(52) U.S. Cl. 315/186

(57) ABSTRACT

A power-saving light string, particularly a battery-powered light string, includes a timing controller mounted to an electrical wire of the light string. The light string is operated to intermittently supply power to bulbs of the light string in an alternate ON/OFF switching fashion that complies with visual persistency of human eyes so as to reduce power consumption.

### (a) TECHNICAL FIELD OF THE INVENTION

The present invention generally relates to the field of light strings, and more particularly to a light string comprising a timing controller that controls the operation of the light string in a power-saved manner.

### (b) DESCRIPTION OF THE PRIOR ART

A conventional light string is actuated/de-actuated for power supply in the manner shown in FIG. 1. The conventional light string, generally designated at 1, comprises an ON/OFF switch 14 that is mounted on an electrical wire 12 of the light string, whereby when the switch is turned on, full power is supplied to the stringed light 13 for lighting the light bulbs thereof Supplying electrical power in this way is completely of no effect of power saving. For a light string that consumes alternate current, this way is just a waste of power; for a light string that consumes direct current, the battery that supplies electrical power to the light string cannot last for long and frequent replacement of battery results. This is certainly not an ideal arrangement and further improvement is needed.

### SUMMARY OF THE INVENTION

The primary purpose of the present invention is to provide a power-saving light string, and particularly a power-saving arrangement for battery-powered light string, wherein a timing controller is additionally mounted to an electrical wire of the light string to be operated in such a way that ON/OFF switching of power supply is repeatedly performed each one-forty eighth seconds, so that lighting of the light string complies with visual persistency to show visually constant lighting. In this way, the power consumption is cut by half so that power saving can be realized and service life of a battery that energizes the light string is extended.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing an arrangement of conventional light string.

FIG. 2 is a schematic view showing an arrangement of light string according to the present invention.

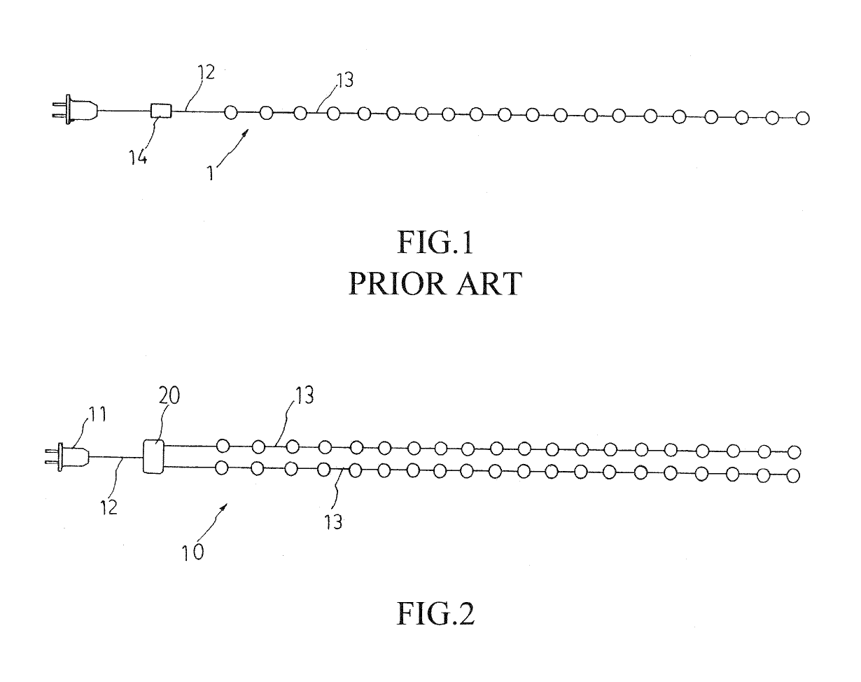

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

As shown in FIG. 2, the present invention provides a power-saving light string, which is particularly a light string powered by a battery, such as

Christmas light, firecracker light, and garden light. In the following description, a Christmas light string is taken as an example for explanation. The light string 10 comprises a power plug 11 that is electrically connected to an electrical wire 12 and one or more stringed lights 13. A timing controller 20 is arranged between the electrical wire 12 and the stringed light 13. The timing controller 20 is operated in such a way that each cycle of successively turning ON and OFF is performed in a period of one twenty-fourth ( 1/24) seconds in order to comply with the one twenty-fourth second period of visual persistency of human eyes. In other words, in each of the 1/24 second switching ON/OFF cycles, ON condition lasts for one forty-eighth ( 1/48) seconds and is switched to OFF condition, which again lasts for one forty-eighth ( 1/48) seconds. In this way, the intermittent supply of power to the stringed lights 13 in the ON condition complies with the visual persistency of human eyes so that the alternate lighting/blackening of the light string causes visually constant lighting due to visual persistency. In this way, the consumption of power is cut by half, so that power saving can be realized and the service life of the battery is extended.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A power-saving light string, particularly a battery-powered light string, comprising a timing controller mounted to an electrical wire of the light string and operated in such a way that power is supplied to light bulbs of the light string in an alternately ON/OFF switching fashion that complies with visual persistency of human eyes so as to reduce power consumption.

2. The power-saving light string according to claim 1, wherein the operation of the timing controller complies with visual persistency period of one twenty-fourth seconds by dividing the period of one twenty-fourth seconds into a one forty-eighth second period of ON condition and a successive one forty-eighth second period of OFF condition, whereby the power is supplied to the light string in an ON/OFF switching manner that complies visual persistency, making alternate lighting and blackening of the light bulbs cause visually constant lighting due to the visual persistency.

3. The power-saving light string according to claim 1, wherein the light string comprises a battery-powered light string, such as Christmas light, firecracker light, and garden light.
